(19) United States
(12) Patent Application Publication
(10) Pub. No.: US 2024/0164234 A1
(43) Pub. Date: May 23, 2024

(54) AGRICULTURAL SWEEP WITH WEAR RESISTANT COATING

(71) Applicant: Osmundson Mfg. Co., Perry, IA (US)

(72) Inventor: Douglas G. Bruce, West Des Moines, IA (US)

(21) Appl. No.: 18/407,711

(22) Filed: Jan. 9, 2024

Related U.S. Application Data
(63) Continuation of application No. 17/163,625, filed on Feb. 1, 2021, now Pat. No. 11,882,777.
Application No. 17/163,625 is a continuation-in-part of application No. 16/934,741, filed on Jul. 21, 2020, now abandoned.

(51) Int. Cl. A01B 15/02

(52) U.S. Cl. CPC A01B 15/02

(57) ABSTRACT

An agricultural device with a wear resistant coating comprising a shank portion that may be attached to an agricultural implement. First and second rear wings connect to an intermediate portion that connects to the shank portion. First and second shoulders are formed at the points where the rear wings meet the intermediate portion, and a patch of wear resistant coating is applied at each of the first and second shoulders. A first edge tapers forwardly from the first rear wing to a point, and a second edge tapers forwardly from the second rear wing to the point. Wear resistant coating may also be applied to the first and second edges or the point. Wear resistant coating may be applied to the agricultural device in a pattern that is specific to soil type.

### CROSS-REFERENCE TO RELATED APPLICATIONS

This application is a continuation of U.S. application Ser. No. 17/163,625 which was filed on Feb. 1, 2021, and is a continuation-in-part of U.S. application Ser. No. 16/934,741 which was filed on Jul. 21, 2020, both of which are incorporated herein fully by reference.

### FIELD OF THE DISCLOSURE

This disclosure relates generally to an agricultural device with a wear resistant coating, and in particular to an agricultural sweep with a wear resistant coating. In one arrangement, the disclosure relates to an agricultural sweep having a patch of wear resistant coating applied to the leading edge of the agricultural sweep. In other arrangements, patches of wear resistant coating may be applied in patterns that are specific to soil type.

### BACKGROUND OF THE DISCLOSURE

Various tillage devices are used to turn and work soil for agricultural purposes. One type of tillage device is a sweep. An agricultural sweep is typically mounted to a gang implement which holds a number of sweeps at a position in which the sweeps travel just below the surface of the earth between crop rows. The purpose of the sweeps is to cut weeds just below the ground surface, thus inhibiting the growth of the weeds and promoting the growth of the row crops.

Various designs for agricultural sweeps exist, an example of which is U.S. Pat. No. 6,508,147 (Bruce). Due to the abrasive nature of the soil that sweeps and other ground engaging agricultural devices encounter, such devices become worn and periodically require replacement. Replacement of ground engaging agricultural devices leads to expense and down time while the worn part is replaced.

For the reasons stated above and for other reasons which will become apparent to those skilled in the art upon reading and understanding the specification, there is a need in the art for an improved agricultural device with wear resistant coating.

Thus, it is a primary object of the disclosure to provide an agricultural device with wear resistant coating that prevents wear of the device.

These and other objects, features, or advantages of the present disclosure will become apparent from the specification and claims.

### BRIEF SUMMARY OF THE DISCLOSURE

The disclosure relates to an improved agricultural device with wear resistant coating. The disclosure relates to an agricultural sweep with wear resistant coating. The disclosure relates to application of wear resistant coating on the leading edge and other areas of an agricultural device.

### BRIEF DESCRIPTION OF THE DRAWINGS

FIG. 1 depicts a perspective view of an agricultural device attached to a shank of an earth working implement moving through soil according to one embodiment.

FIG. 2 depicts a perspective view of a typical wear pattern experienced by an agricultural device according to one embodiment.

FIG. 3 depicts how wear resistant coating is edge applied to a top side of an agricultural device according to one embodiment.

FIG. 4 depicts a top view of an agricultural device with wear coating according to one embodiment.

FIG. 5 depicts a top view of an agricultural device with wear coating according to one embodiment.

FIG. 6 depicts a top view of an agricultural device with wear coating according to one embodiment.

FIG. 7 depicts a top view of an agricultural device with wear coating according to one embodiment.

FIG. 8 depicts a top view of an agricultural device with wear coating according to one embodiment.

FIG. 9 depicts a top view of an agricultural device with wear coating according to one embodiment.

FIG. 10 depicts a top view of an agricultural device with wear coating according to one embodiment.

FIG. 11 depicts a top view of an agricultural device with wear coating according to one embodiment.

FIG. 12 depicts a top view of an agricultural device with wear coating according to one embodiment.

FIG. 13 depicts a top view of an agricultural device with wear coating according to one embodiment.

FIG. 14 depicts a top view of an agricultural device with wear coating according to one embodiment.

### DETAILED DESCRIPTION

In the following detailed description of the embodiments, reference is made to the accompanying drawings which form a part hereof, and in which is shown by way of illustration specific preferred embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the present disclosures. The following detailed description is, therefore, not to be taken in a limiting sense, and the scope of the present disclosure is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description, and are not intended to be used as limitations. Accordingly, orientation of an object or a combination of objects may change without departing from the scope of the disclosure.

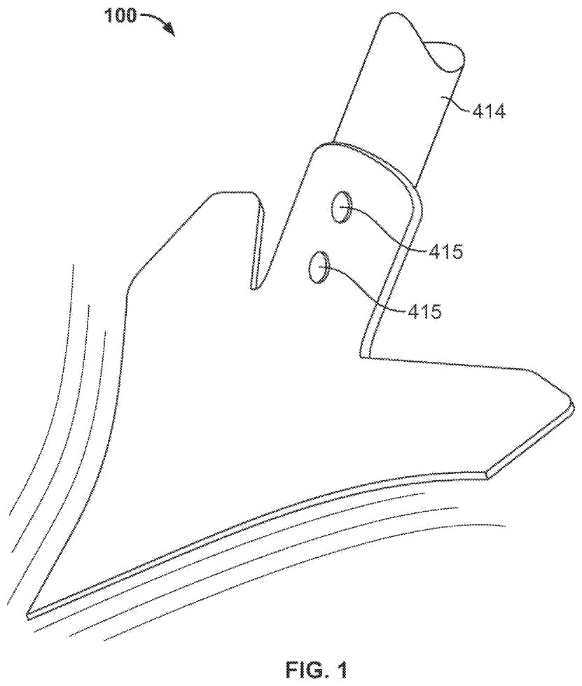

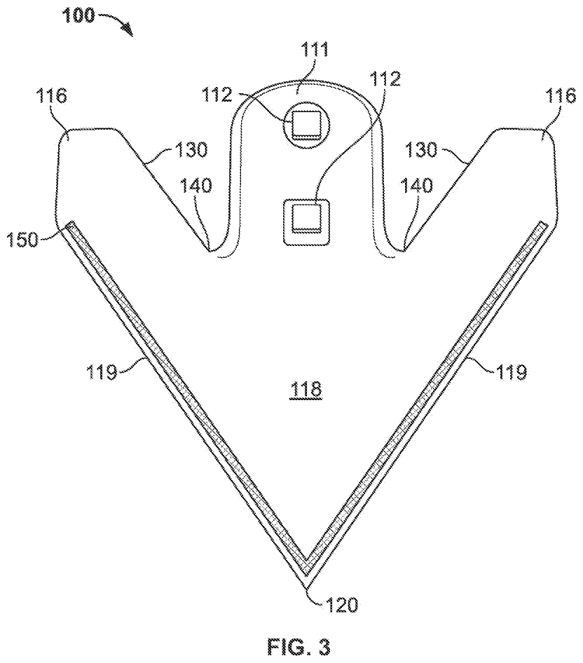

Throughout the disclosure, agricultural device 100 may be referred to as simply “device 100.” As shown in FIGS. 3-14, an example of an agricultural device 100 comprises a shank portion 111 with holes 112 therein for allowing the shank portion 111 to be attached to a shank 414 of an agricultural tillage implement with bolts 415 as shown in FIG. 1. First and second rear wings 116 are connected by an intermediate portion 118.

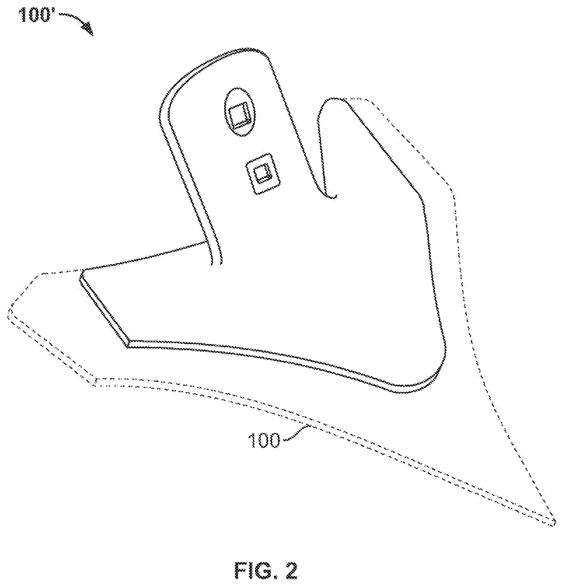

Edges 119 taper forwardly from a trailing edge 130 to a tip 120. For purpose of this disclosure, tip 120 may be referred to as tip 120 or point 120. The edges 119 and tip 120 together form a portion of device 100 referred to as the leading edge. The points at which the rear wings 116 meet the intermediate portion 118 are referred to as the shoulders 140. Tip 120 may have nominal width (i.e., the lines of edges 119 intersect at the tip 120 forming a point), or tip 120 may form a chisel point which is tapered in thickness from having practically no thickness at the extreme front thereof to a rear portion thereof which is substantially the same thickness as the plate from which the entire sweep is constructed. As shown in FIG. 2, the device 100 gradually wears from the original shape shown in dashed lines to the condition 100′ shown in solid lines. The shape of device 100 is substantially similar to the earth working sweep disclosed in U.S. Pat. No. 6,508,147, which is incorporated herein by reference.

The device 100 may be constructed from steel or any other metal or material suitable for use as a ground-engaging device. The device 100 can be as wide or narrow as desired.

As shown in FIG. 1, in operation, soil (depicted as curved lines) first encounters device 100 at tip 120 and edges 119. The soil continues to move across device 100 as device 100 is propelled through the soil, and the soil that travels over the top of device 100 ultimately moves off device 100 at its trailing edge 130. As shown in FIG. 2, the device 100 gradually wears from its original shape 100 shown in dashed lines to the condition 100′ shown in solid lines. Wear occurs at the tip 120 and edges 119 as a result of encountering soil, rocks, roots, and other objects.

To extend the useful life of device 100, a wear resistant coating 150 may be applied at tip 120, edges 119, shoulders 140, or any combination of tip 120, edges 119, and shoulders 140. Wear resistant coating 150 may comprise carbide particles, tungsten carbide coating, and the like. However, wear resistant coating 150 may be comprised of any material or composition without departing from the disclosure. The wear resistant coating 150 may be applied to device 100 using any application method. For example, wear resistant coating 150 may be welded, sprayed, rolled, brushed, dabbed, etched, deposited, applied by laser, deposited by plasma or detonation gun, or brushed onto device 100. Alternatively, device 100 may be dipped in wear resistant coating 150.

Wear Resistant Coating 150 on the Leading Edge as Shown in FIGS. 3-14

As shown in FIGS. 3-14, wear resistant coating 150 may be applied to the leading edge of device 100. A line of wear resistant coating 150 may be applied to the tip 120. Additionally, or alternatively, a line of wear resistant coating 150 may be applied to or near edges 119 or a portion of edges 119. Wear resistant coating 150 may be applied to the top, bottom or side of tip 120 and/or edges 119. Wear resistant coating 150 may be applied to the shoulders 140 in addition to the leading edge of device 100, or wear resistant coating 150 may be applied to the leading edge only.

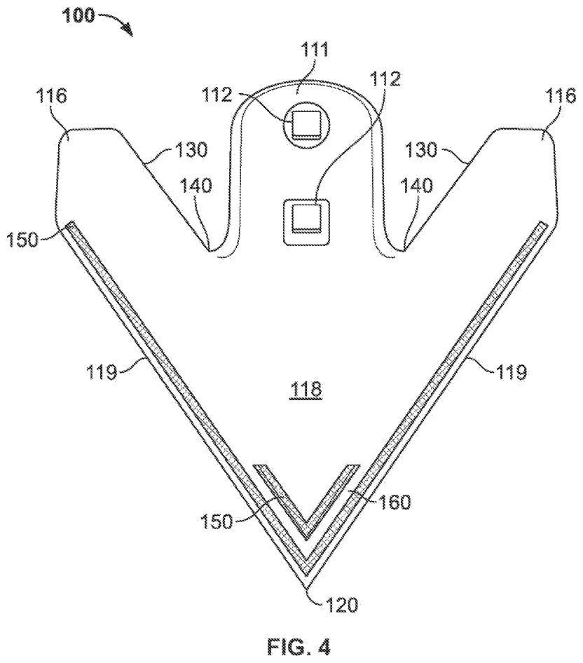

Wear Resistant Coating 150 at the Tip 120 as Shown in FIGS. 4-14

As shown in FIGS. 4-14, wear resistant coating 150 may be applied to the leading edge of device 100. A patch of wear resistant coating 150 may additionally or alternatively be applied to a first location 160 at the tip 120. The patch of wear resistant coating 150 at first location 160 may comprise a triangular, circular, semi-circular, square or any other shaped patch of wear resistant coating 150 that completely or partially covers tip 120. The patch of wear resistant coating 150 may be applied to the top, bottom or side of tip 120. Wear resistant coating 150 may be applied to the shoulders 140 in addition to the leading edge of device 100, or wear resistant coating 150 may be applied to the tip 120 only.

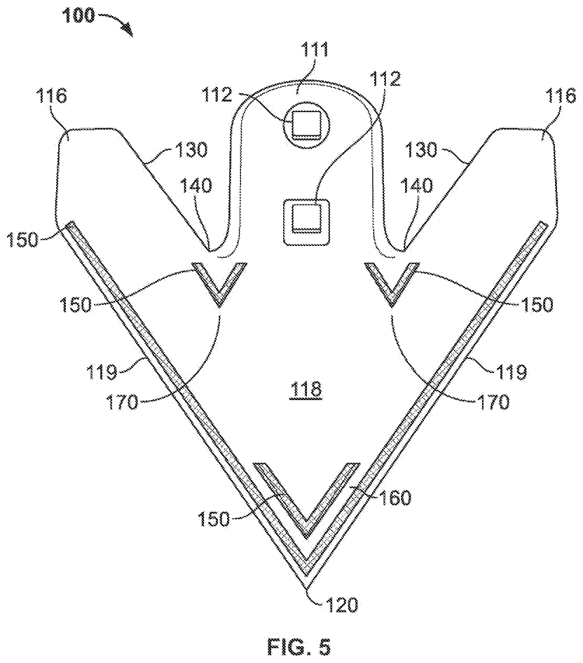

Wear Resistant Coating 150 as Shown in FIGS. 5-10 and 12-14

As shown in FIGS. 5-10 and 12-14, wear resistant coating 150 may be applied at a second location 170 at each shoulder 140. The patches of wear resistant coating 150 may comprise triangular, circular, semi-circular, square or any other shaped patches of wear resistant coating 150 that completely or partially cover shoulders 140. The patches of wear resistant coating 150 may be applied to the top, bottom or side of shoulders 140. Wear resistant coating 150 may be applied to the leading edge or tip 120 in addition to the shoulders 140, or wear resistant coating 150 may be applied to the shoulders 140 only.

In an embodiment of the invention, a wear resistant agricultural device 100 comprises a shank portion 111 configured for attachment to a tillage implement; a first rear wing 116 and a second rear wing 116, wherein the first and second rear wings 116 are connected to an intermediate portion 118 and an end of the intermediate portion 118 connects to the shank portion 111, thereby forming a first shoulder 140 where the first rear wing 116 meets the intermediate portion 118 and a second shoulder 140 where the second rear wing 116 meets the intermediate portion 118; a first edge 119 tapering forwardly from the first rear wing 116 to a point 120; a second edge 119 tapering forwardly from the second rear wing 116 to the point 120; and a patch of wear resistant coating 150 applied at each of the first and second shoulders 116. In this embodiment, a patch of wear resistant coating 150 may be applied at the point 120 and the first and second edges 119 are uncoated. Alternatively, or additionally, the wear resistant agricultural device 100 may comprise a wear resistant coating 150 applied to each of the first and second edges 119 and the point 120.

Wear Resistant Coating 150 Patterns Based on Soil Type as Shown in FIGS. 3-14

Agricultural soil type varies from location to location, and soil type affects the wear pattern agricultural device 100 experiences. Wear resistant coating 150 may be applied in differing patterns based on soil type as shown in FIGS. 3-14. The shape of each patch of wear resistant coating 150 directs the wear pattern that will be experienced by device 100.

A first patch of wear resistant coating 150 may be applied in a soil-specific pattern to a first location 160 on the top side of agricultural device 100 at or near tip 120. A second patch of wear resistant coating 150 may be applied in a soil-specific pattern to a second location 170 on the top side of agricultural device 100 at or near each shoulder 140. A third patch of wear resistant coating 150 may be applied in a soil-specific pattern to a third location 180 on the top side of agricultural device 100 at or near the shank portion 111. Patches of wear resistant coating 150 may be applied to any combination or subset of the first location 160, second location 170, and third location 180 or may be applied to any other location on the surface of the device 100 without departing from the scope of the disclosure. Patches of wear resistant coating 150 may be applied one inch or less from the location where wear starts. Wear resistant coating 150 may be applied in any thickness without departing from the scope of the disclosure.

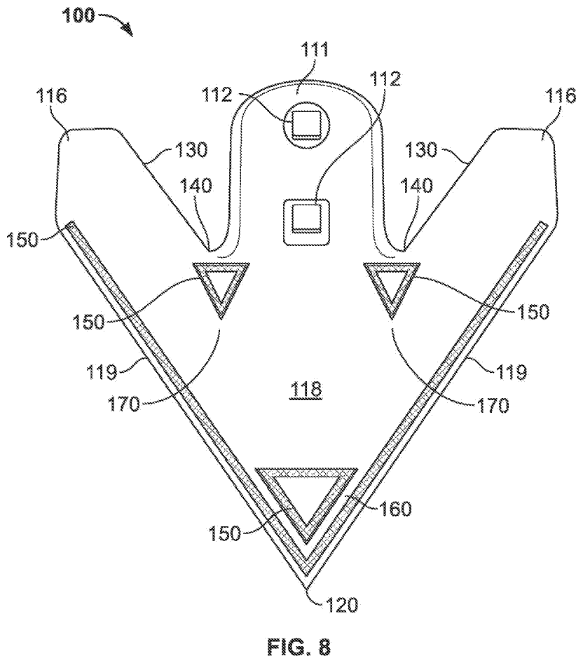

Patches of wear resistant coating 150 may be solid, filled in shapes or open, unfilled shapes. Further, patches of wear resistant coating 150 may be closed shapes in which the entire perimeter of the shape is applied as shown in FIGS. 8, 10, and 14, or patches of wear resistant coating 150 may be open shapes in which a portion of the perimeter of the shape is omitted as shown in FIGS. 4-7 and 11-12. Any combination of filled in, unfilled, open, and closed shapes may be used without departing from the scope of the disclosure.

Soil types are highly variable. In particular, there are many types of sandy or abrasive soils, each of which may produce a unique wear pattern. It is anticipated that some equipment owners may experience different wear patterns based on their specific soil, and the shapes, dimensions, and locations of wear resistant coating 150 may be customized to counter specific wear patterns. Further, shapes, dimensions, locations, and thicknesses of wear resistant coating 150 may be customized to achieve an acceptable balance of wear resistant properties and manufacturing cost for a particular customer. Customers may submit worn agricultural devices 100 to the manufacturer for analysis of wear patterns, and subsequent agricultural devices 100 produced for that individual customer will have customized wear resistant coating 150 patterns that are most effective for the customer's specific soil type.

In an embodiment of the invention, a wear resistant agricultural device 100 comprises a shank portion 111 configured for attachment to a tillage implement; a first rear wing 116 and a second rear wing 116, wherein the first and second rear wings 116 are connected to an intermediate portion 118 and an end of the intermediate portion 118 connects to the shank portion 111, thereby forming a first shoulder 140 where the first rear wing 116 meets the intermediate portion 118 and a second shoulder 140 where the second rear wing 116 meets the intermediate portion 118; a first edge 119 tapering forwardly from the first rear wing 116 to a tip 120; a second edge 119 tapering forwardly from the second rear wing 116 to the tip 120; and a pattern of wear resistant coating 150 applied on a top side of the agricultural device 100 at a first location 160 at or near the tip 120 and a second location 170 at or near each of the first and second shoulders 140, wherein the pattern of wear resistant coating 150 is configured to protect the agricultural device 100 from a particular soil type.

As shown in FIG. 4, an open triangle or “v” shaped patch of wear resistant coating 150 may be applied at a first position 160 on the top side of an agricultural device 100. A line of wear resistant coating 150 may also be applied along all or part of the leading edge of agricultural device 100.

As shown in FIG. 5, an open triangle or “v” shaped patch of wear resistant coating 150 may be applied at a first position 160 on the top side of an agricultural device 100. Additional open triangle or “v” shaped patches of wear resistant coating 150 may also be applied at each second position 170. A line of wear resistant coating 150 may also be applied along all or part of the leading edge of agricultural device 100.

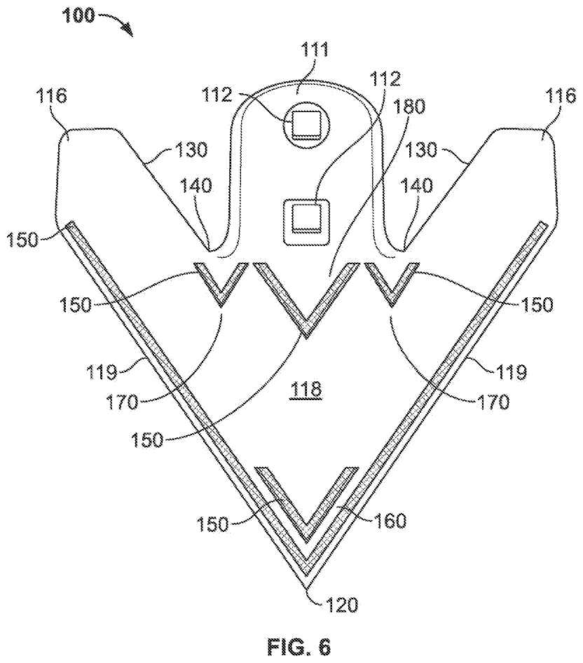

As shown in FIG. 6, an open triangle or “v” shaped patch of wear resistant coating 150 may be applied at a first position 160 on the top side of an agricultural device 100. Additional open triangle or “v” shaped patches of wear resistant coating 150 may also be applied at each second position 170. An additional open triangle or “v” shaped patch of wear resistant coating 150 may also be applied at a third position 180. A line of wear resistant coating 150 may also be applied along all or part of the leading edge of agricultural device 100.

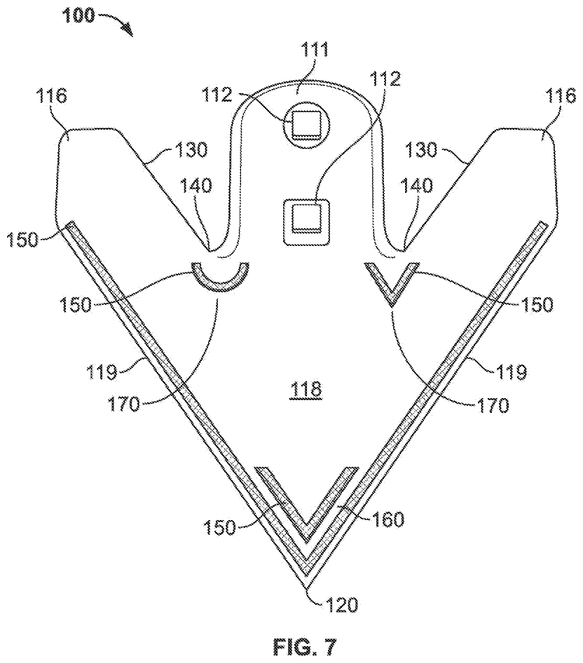

As shown in FIG. 7, an open triangle or “v” shaped patch of wear resistant coating 150 may be applied at a first position 160 on the top side of an agricultural device 100. An additional open triangle or “v” shaped patch of wear resistant coating 150 may also be applied at a second position 170 near one shoulder 140, and an open semicircle shaped patch of wear resistant coating 150 may be applied at a second position 170 near the other shoulder 140. A line of wear resistant coating 150 may also be applied along all or part of the leading edge of agricultural device 100.

As shown in FIG. 8, a closed triangle shaped patch of wear resistant coating 150 may be applied at a first position 160 on the top side of an agricultural device 100. Additional closed triangle shaped patches of wear resistant coating 150 may also be applied at each second position 170. A line of wear resistant coating 150 may also be applied along all or part of the leading edge of agricultural device 100.

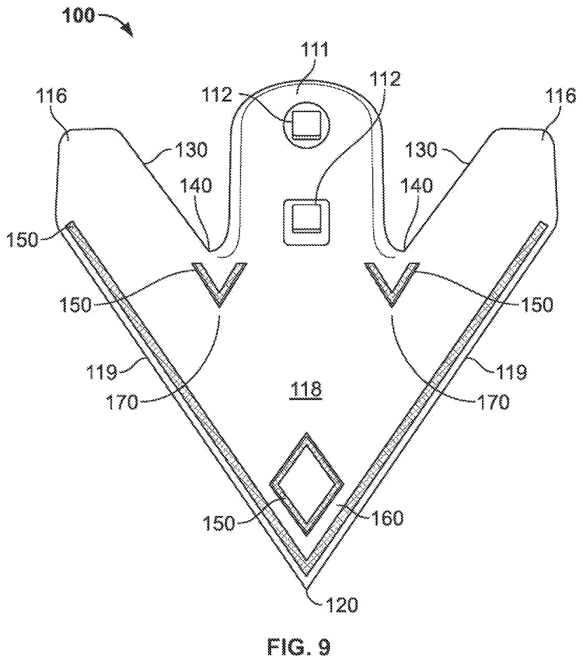

As shown in FIG. 9, a closed diamond shaped patch of wear resistant coating 150 may be applied at a first position 160 on the top side of an agricultural device 100. Additionally, open triangle or “v” shaped patches of wear resistant coating 150 may also be applied at each second position 170. A line of wear resistant coating 150 may also be applied along all or part of the leading edge of agricultural device 100.

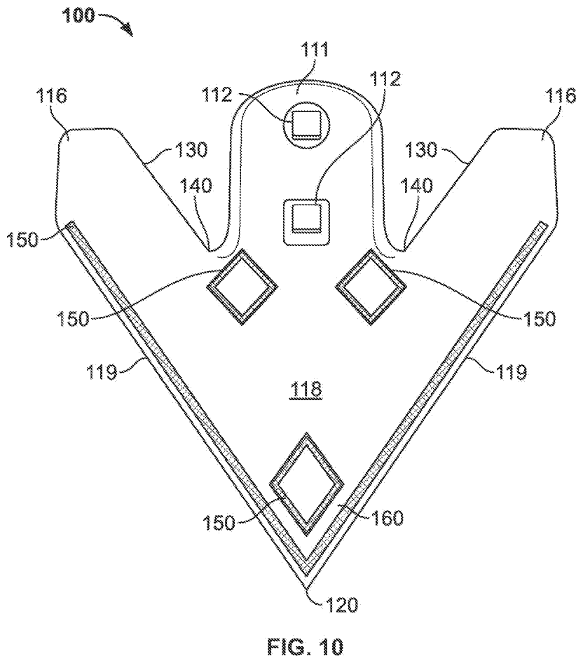

As shown in FIG. 10, a closed square, box, or diamond shaped patch of wear resistant coating 150 may be applied at a first position 160 on the top side of an agricultural device 100. Additional closed square, box, or diamond shaped patches of wear resistant coating 150 may also be applied at each second position 170. A line of wear resistant coating 150 may also be applied along all or part of the leading edge of agricultural device 100.

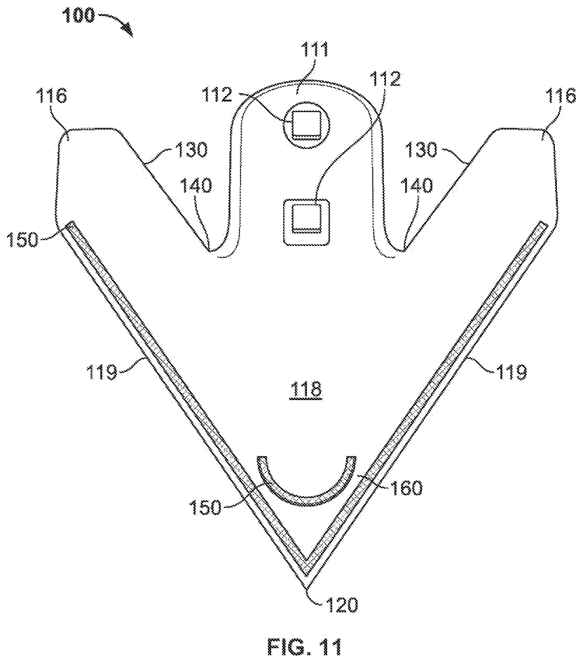

As shown in FIG. 11, an open semicircle shaped patch of wear resistant coating 150 may be applied at a first position 160 on the top side of an agricultural device 100. A line of wear resistant coating 150 may also be applied along all or part of the leading edge of agricultural device 100.

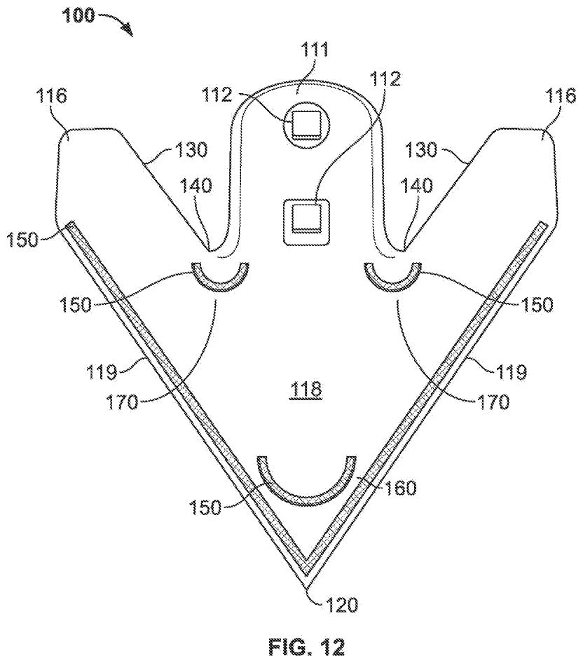

As shown in FIG. 12, an open semicircle shaped patch of wear resistant coating 150 may be applied at a first position 160 on the top side of an agricultural device 100. Additional open semicircle shaped patches of wear resistant coating 150 may also be applied at each second position 170. A line of wear resistant coating 150 may also be applied along all or part of the leading edge of agricultural device 100.

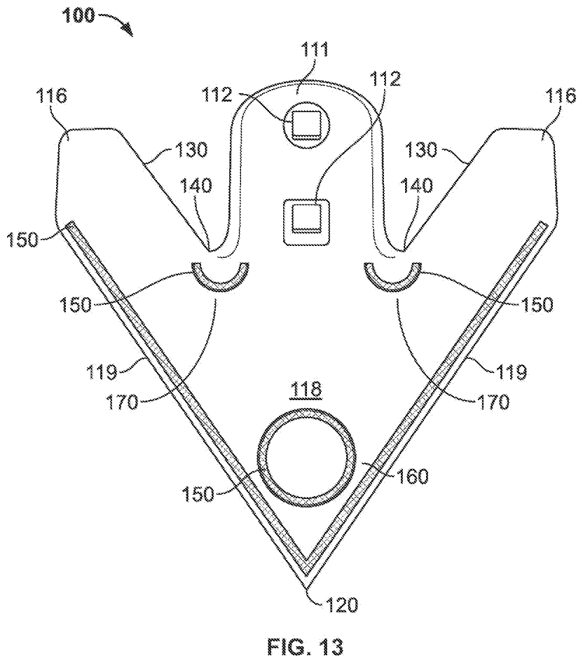

As shown in FIG. 13, a closed circle shaped patch of wear resistant coating 150 may be applied at a first position 160 on the top side of an agricultural device 100. Additionally, open semicircle shaped patches of wear resistant coating 150 may be applied at each second position 170. A line of wear resistant coating 150 may also be applied along all or part of the leading edge of agricultural device 100.

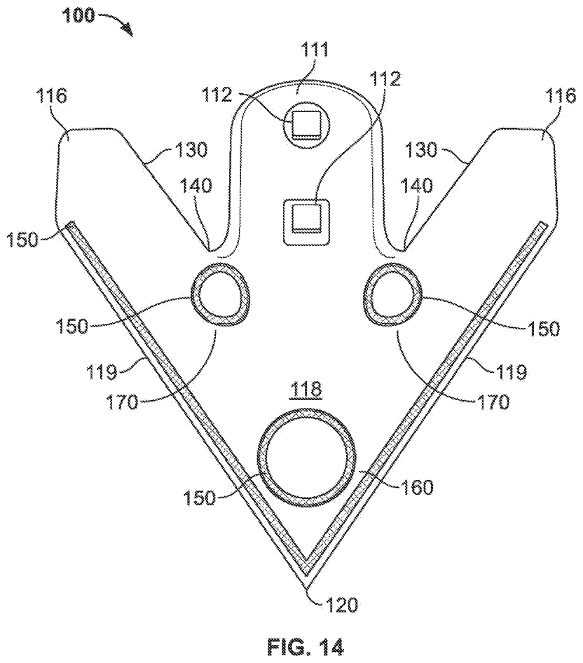

As shown in FIG. 14, a closed circle shaped patch of wear resistant coating 150 may be applied at a first position 160 on the top side of an agricultural device 100. Additional closed circle shaped patches of wear resistant coating 150 may be applied at each second position 170. A line of wear resistant coating 150 may also be applied along all or part of the leading edge of agricultural device 100.

Lines of wear resistant coating 150 may be applied at or near the edges 119 on the bottom side of agricultural device 100. The lines of wear resistant coating 150 may extend along the entirety of each edge 119 from the tip 120 to the rear wings 116, or the lines of wear resistant coating 150 may be applied at or near only a portion of each edge 119.

Each patch of wear resistant coating 150 may be applied as shown in FIGS. 3-14; alternatively any patch of wear resistant coating 150 may be rotated by 90 to 180 degrees. Further, it is envisioned that patches of wear resistant coating 150 will be applied to the first location 160, second location 170, and third location 180 on the top side of agricultural device 100 and a line of wear resistant coating 150 applied to each edge 119 on the bottom side of agricultural device 100 as shown and previously described; however, the patches of wear resistant coating 150 may alternatively be applied to a location corresponding to the first location 160, a location corresponding to the second location 170, and a location corresponding to the third location 180 on the bottom side of agricultural device 100 and a line of wear resistant coating 150 applied to each edge 119 on the top side of agricultural device 100 without departing from the scope of the disclosure.

The agricultural device 100 with wear resistant coating 150 has many benefits and advantages including, but not limited to reducing the expense and lost working time associated with replacing worn ground engaging components. These and other benefits and advantages of the agricultural device 100 are apparent from the specification and claims.

### REFERENCE NUMERALS

100—agricultural device, also called device
100′—a worn condition of agricultural device 100
111—shank portion
112—hole in shank portion 111
116—rear wing
118—intermediate portion
119—edges
120—tip or point
130—trailing edge
140—shoulders
150—wear resistant coating
160—first location
170—second location
180—third location
414—shank
415—bolt

1-10. (canceled)

11. A wear resistant agricultural device comprising:
a shank portion configured for attachment to a tillage implement;
an intermediate portion connected to the shank portion;
a point connected to the intermediate portion;
one or more shoulder portions connected intermediate portion about opposite of the point; and
one or more patches of wear resistant coating applied at the one or more shoulder portions.

12. The wear resistant agricultural device of claim 11, further comprising an additional patch of wear resistant coating applied at the point.

13. The wear resistant agricultural device of claim 11, wherein the wear resistant coating comprises carbide particles.

14. The wear resistant agricultural device of claim 11, wherein the one or more patches of wear resistant coating each comprise a shape with a closed perimeter.

15. The wear resistant agricultural device of claim 11, wherein the one or more patches of wear resistant coating comprise a generally triangular shape.

16. The wear resistant agricultural device of claim 11, wherein the one or more patches of wear resistant coating comprise a generally square shape.

17. The wear resistant agricultural device of claim 11, wherein the one or more patches of wear resistant coating comprise a generally rectangular shape.

18. The wear resistant agricultural device of claim 11, wherein the one or more patches of wear resistant coating comprise a generally circular shape.

19. The wear resistant agricultural device of claim 11, wherein the one or more patches of wear resistant coating comprise a generally semi-circular shape.

20. A wear resistant agricultural device comprising:
a shank portion configured for attachment to a tillage implement;
an intermediate portion connected to the shank portion;
a point connected to the intermediate portion;
a first shoulder portion connected intermediate portion about opposite of the point;
a second shoulder portion connected intermediate portion about opposite of the point;
a first patch of wear resistant coating applied at the first shoulder portion; and
a second patch of wear resistant coating applied at the second shoulder portion.

19. The wear resistant agricultural device of claim 18, wherein the wear resistant coating comprises carbide particles.

20. The wear resistant agricultural device of claim 18, wherein the one or more patches of wear resistant coating each comprise a shape with a closed perimeter.

21. The wear resistant agricultural device of claim 18, wherein the one or more patches of wear resistant coating comprise a generally triangular shape.

22. The wear resistant agricultural device of claim 18, wherein the one or more patches of wear resistant coating comprise a generally square shape.

23. The wear resistant agricultural device of claim 18, wherein the one or more patches of wear resistant coating comprise a generally rectangular shape.

24. The wear resistant agricultural device of claim 18, wherein the one or more patches of wear resistant coating comprise a generally circular shape.

25. The wear resistant agricultural device of claim 18, wherein the one or more patches of wear resistant coating comprise a generally semi-circular shape.

26. A wear resistant agricultural device comprising:
an intermediate portion;
a point connected to the intermediate portion;
one or more shoulder portions connected intermediate portion about opposite of the point;

27. The wear resistant agricultural device of claim 26, wherein the wear resistant coating comprises carbide particles.

28. The wear resistant agricultural device of claim 26, wherein the one or more patches of wear resistant coating each comprise a shape with a closed perimeter.

29. The wear resistant agricultural device of claim 26, wherein the one or more patches of wear resistant coating comprise a generally triangular shape.

30. The wear resistant agricultural device of claim 26, wherein the one or more patches of wear resistant coating comprise a generally square shape.
